(19) United States
(12) Patent Application Publication
(10) Pub. No.: US 2003/0051245 A1
(43) Pub. Date: Mar. 13, 2003

(54) Method and apparatus for adaptively storing program guide data

(76) Inventor: Scott Edward Klopfenstein, Fishers, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/092,213

(22) Filed: Mar. 6, 2002

Related U.S. Application Data
(60) Provisional application No. 60/318,058, filed on Sep. 7, 2001.

(51) Int. Cl. G06F 3/00; H04N 5/445; G06F 13/00

(52) U.S. Cl. 725/46; 725/44

(57) ABSTRACT

Method and apparatus suitable for use within a receiver for storing program guide information, wherein program guide data associated with non-preferred programming is reduced or deleted from a program guide database.

### CROSS REFERENCES TO RELATED APPLICATIONS

This application claims the benefit of U.S. Provisional Patent Application Serial No. 60/318,058 filed Sep. 7, 2001, which is incorporated herein by reference in its entirety. This application is related to other simultaneously filed U.S. Patent Applications, each having a common assignee. The related and simultaneously filed applications are: “Method and Apparatus For Adaptively Storing Program Guide Data,” Ser. No. XXXX filed Month XX, Year and “Method and Apparatus For Adaptively Storing Program Guide Data,” Ser. No. XXXX filed Month XX, Year, both of which are incorporated herein by reference in their entireties.

### FIELD OF THE INVENTION

This invention relates to electronic program guides for televisions and receivers.

### BACKGROUND OF THE INVENTION

Television viewers, especially associated with premium cable and satellite programming services, often use an electronic program guide to select a program for viewing from a service provider or broadcast center. For example, the viewer may use the program guide to order a pay-per-view selection from a movie provider. Similarly, the viewer may select a particular category of programming, such as “Sports,” and select a program for viewing from those offered in that category. Such program guides are generally provided using a video receiver coupled to a display device, e.g., a television set. Examples of a typical video receiver include a set top terminal, a Digital Broadcast Satellite (DBS) receiver, an Integrated Receiver-Decoder (IRD), and other types of television receivers.

To maintain a current program schedule in the program guide, the receiver periodically receives program guide information for a program schedule. Current specifications for an Advanced Program Guide (APG) require the storage of all received program guide information within a memory of the video receiver. Such memory is typically limited in size.

### SUMMARY OF THE INVENTION

Method and apparatus suitable for use within a receiver for storing program guide information, wherein program guide data associated with non-preferred programming is reduced or deleted from a program guide database.

A method according to an embodiment of the invention for adaptively storing in a memory used to store program guide information for a plurality of programs comprises determining whether a first program in the program guide is non-preferred by a user; and reducing program guide information associated with the first program from said memory if the first program is non-preferred by the user.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a broadcast system;

FIG. 2 depicts a block diagram of a receiver suitable for use in the system of FIG. 1;

FIG. 3 depicts exemplary program guide screen imagery;

FIG. 4 depicts an embodiment of a program guide database; and

FIG. 5 depicts a flow diagram of a method for allocating a memory in a receiver.

To facilitate understanding, identical reference numerals have been used, where possible, to designate identical elements that are common to the figures.

### DETAILED DESCRIPTION

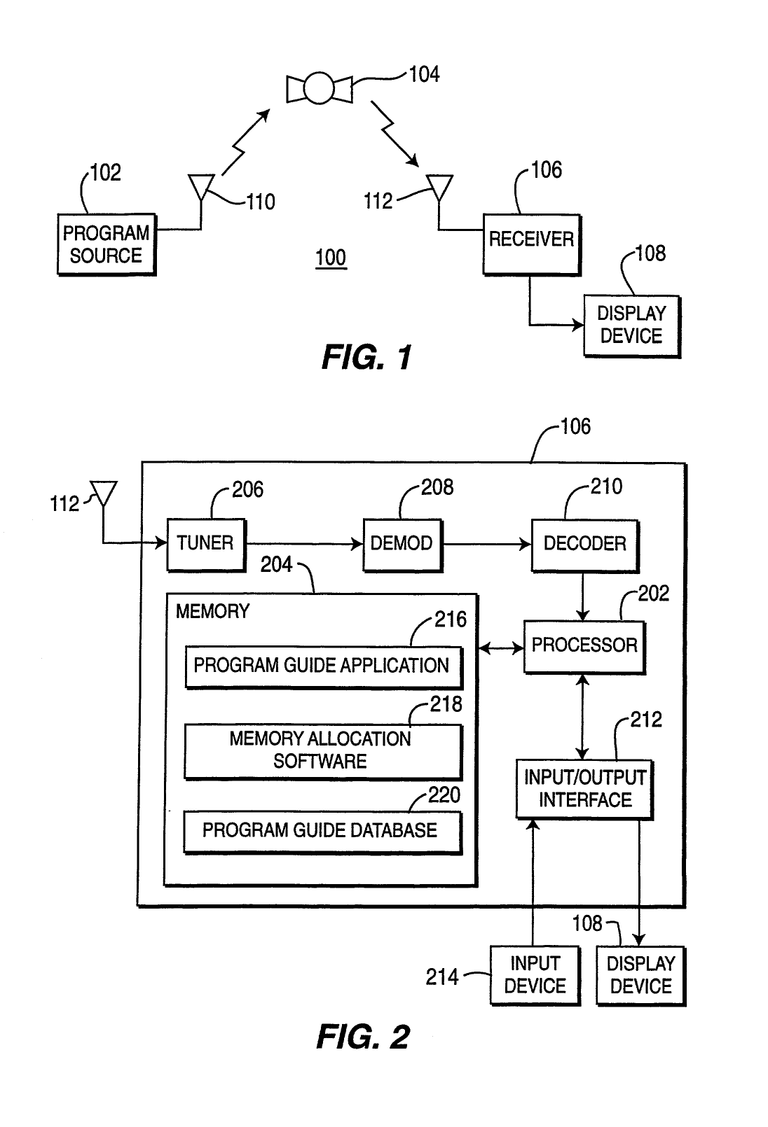

FIG. 1 depicts a high level block diagram of a broadcast system 100 for providing a program guide to a viewer of a television receiver set top terminal (STT) or other video receiver device. The system 100 of FIG. 1 comprises a program source 102, a satellite 104, a receiver 106 and a display device 108. Although one program source 102, one satellite 104 and one television receiver 106 is depicted in FIG. 1, the system 100 may comprise multiple program sources 102, multiple satellites 104 and multiple receivers 106. Additionally, the video broadcast system 100 is not limited to satellite transmission of video signals. For example, the system 100 may implement terrestrial stations to broadcast video signals.

The program source 102 broadcasts one or more video, audio, audiovisual and/or data signals via an antenna 110. In the case of a program comprising video, audio or audiovisual signals, the program is broadcast according to a program schedule. The program schedule defines the time and transmission channel used to broadcast the program for one or more geographic viewing areas. In one embodiment, the signals may comprise a program in the form of an MPEG-formatted data stream. The program may comprise a television program, a movie, a live broadcast, an advertisement, or some other form of audiovisual signal.

The satellite 104 receives the signals from the signal source 102 and rebroadcasts the signals to a predefined geographical viewing area. Additionally, the satellite 104 may receive a request from a video receiver 106 to broadcast “program guide information.” In one embodiment, the program guide information may comprise Advanced Program Guide (APG) information.

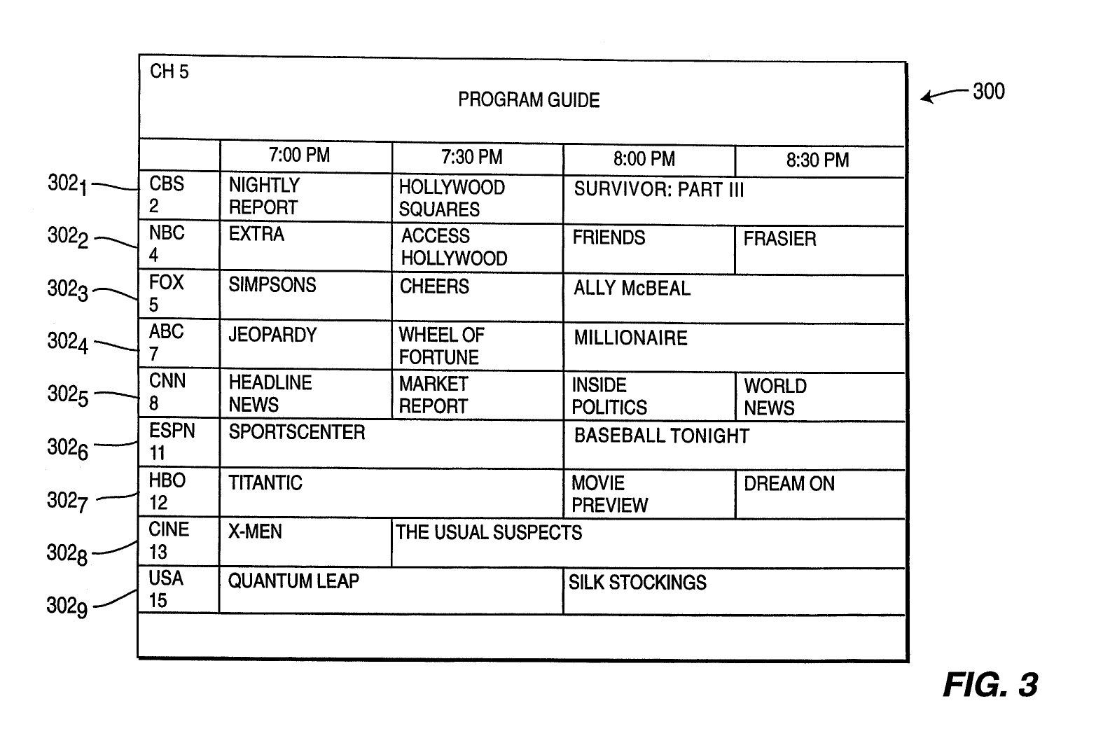

The receiver 106 receives the program guide information via an antenna 112 and stores the received information in a memory. The receiver 106 uses the program guide information to provide a program guide on a display device or some other form of output device. The program guide contains a listing of programs scheduled for broadcast over each channel accessible by the receiver 106. Exemplary program guide display imagery is described below with respect to FIG. 3.

Programs are scheduled for broadcast in accordance to a program schedule of a predetermined time frame or schedule length. The program guide displays only a current portion of the program schedule. The remainder of the program schedule is retained as program guide information stored in the memory of the receiver. The remainder portion of the program schedule is that portion of program guide scheduled for display in the future. As such, to maintain a current program guide, the receiver 106 must periodically obtain program guide information.

A viewer of the program guide may select a program displayed thereon. Once this occurs, the receiver 106 tunes to the satellite 104 (or satellite transponder/channel) broadcasting the selected program. The program is then received at the receiver 106 and provided to the display device 108. The receiver 106 is further described below with respect to FIG. 2.

FIG. 2 depicts a block diagram of the receiver 106 in the video system 100 of FIG. 1. In one embodiment, the video receiver 106 comprises a set top terminal (STT) or television receiver. The receiver 106 of FIG. 2 comprises a processor 202, a memory 204, a tuner 206, a demodulator 208 and a decoder 210. The receiver 106 may also comprise an input/output interface 212 and various support circuits (not shown).

The tuner 206 receives a plurality of signals from the satellite 104 and selects the appropriate signal or channel of interest. The demodulator 208 demodulates the selected signal. Common forms of demodulation include QAM (Quadrature Amplitude Modulation), QPSK (Quadrature Phase Shift Keying), and the like. The decoder 210 decodes program stream or program guide information within the demodulated signal. The decoder 210 may perform error correction such as forward error correction (FEC) as known to those skilled in the art.

The memory 204 stores software and data structures for the operation of the receiver 106. In one embodiment, the memory 204 stores a program guide application 216, memory allocation software (application) 218 and a program guide database 220. The memory 204 may comprise a combination of memory devices including random access memory (RAM), nonvolatile or backup memory (e.g., programmable or flash memories, read only memories (ROM), and the like).

The program guide application 216 comprises software programs having instructions which, when executed by the processor 202, provide program guide functionality in the television system 100. In one embodiment, the program guide application 216 may include a software program operative to monitor viewing habits of a user or viewer. The viewing habits or history may include a history of program selections or a history of selecting a particular genre of program, e.g., sports, romance, comedy, drama, and the like. The program guide application 216 then uses the viewing habits to suggest or estimate programs or the types of programs that the viewer is likely to watch or not likely to watch.

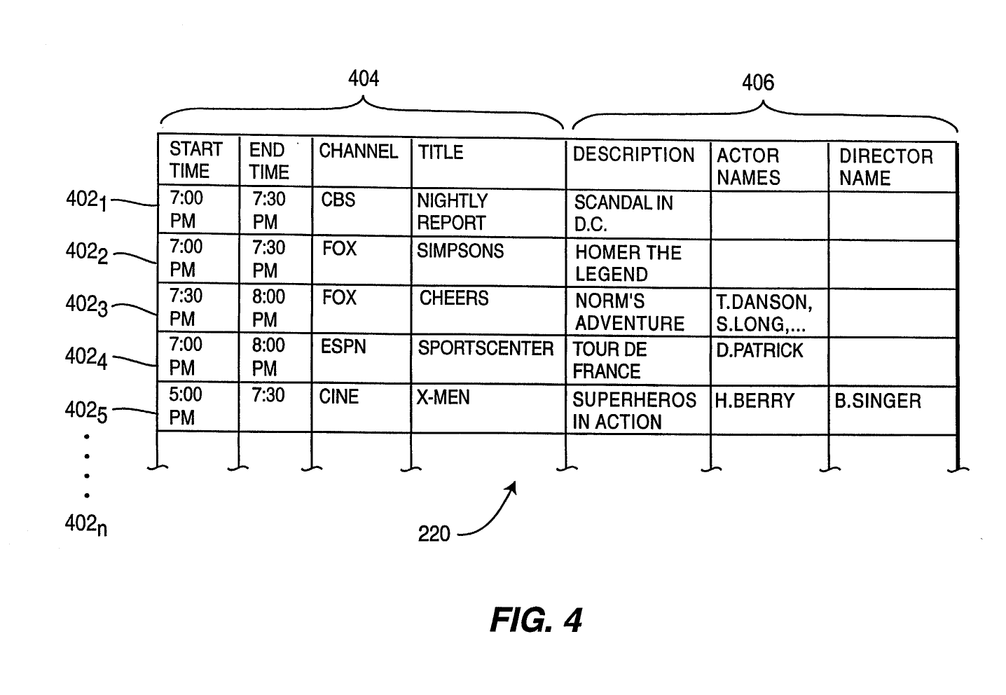

The memory allocation software 218 comprises a software program with instructions to allocate the storage of program guide information in the memory 204. The program guide database 220 contains program guide information relating to channels, schedules and programs in the program schedule. One embodiment of the program guide database 220 is further described with respect to FIG. 4.

The processor 202 executes instructions contained in the program guide application 216 to enable the receiver 106 to provide a program guide function and other functionality as described herein. Additionally, the processor 202 executes instructions contained in the memory allocation software 218 to enable the receiver 106 to implement various embodiments of the present invention.

The input/output interface 212 comprises controllers used to couple the processor 202 to the input device 214 and the display device 108. The input/output interface 212 enables the processor 202 to receive commands from the input device 214 and to provide the program guide and the selected program to the display device 108. The interface 212 may comprise, for example, an NTSC, PAL, SECAM or HDTV presentation device. The input device 214 may comprise any device utilized to provide input to the receiver 102, e.g., to access program information for a program shown on the program guide or to select a television program on a channel. Examples of the input device 214 include a remote control, a keypad, a microphone, a touch screen, and the like.

Those programs that are likely to be watched by a user are deemed to be preferred programs, while those programs that are not likely to be watched by a viewer are deemed to be non-preferred programs. The invention operates to reduce the amount of memory used to store program guide information pertaining to non-preferred programs such that program guide information pertaining to more programs may be stored, or that the program guide information associated with preferred programs may be increased in terms of program description and other parameters.

In one embodiment, program guide information comprises “basic program information” and “extended program information.” Basic programming information includes any channel, scheduling and programming information displayable on the program guide. Extended program information comprises additional information about the program accessible via the program guide.

The receiver 106 minimizes the amount of program guide information stored in the memory 204 for programs that are not of interest to the viewer by discarding or deleting some or all of the corresponding extended program guide information. By deleting this information, the memory 204 thus conserved may be utilized to increase the extended program guide information associated with preferred programming or increase the time-slice size for the stored program guide information. Additionally, the receiver 106 may use different levels of storing program information in the memory. For example, the receiver 106 may store some (or predetermined types) of extended program information for programs of different levels of interest.

FIG. 3 depicts exemplary program guide screen imagery. Specifically, the program guide screen imagery 300 of FIG. 3 may be generated by the receiver 106 for display upon the display device 108. The program guide imagery 300 depicts a table of various programs available at different channels 302₁, 302₂, . . . , 302ₙ (collectively channels 302). The programs are displayed for a predetermined time frame or schedule length, illustratively two hours. While the program guide 300 of FIG. 3 lists programs for nine channels, it will be appreciated that the program guide 300 may list any number of channels for different schedule times.

In one embodiment, the program guide 300 represents each program as a button accessible by a viewer. The viewer may use the input device 214, e.g., a remote control, to access the button via a cursor or highlight. If the viewer accesses the button, the program guide 300 may display additional information about a corresponding program. The additional information may comprise “extended information” such as description of an episode, actor names, director names, and the like.

FIG. 4 depicts an embodiment of a program guide database 220 stored in the memory 204 of the video receiver 106. In one embodiment, the program guide database 220 comprises a plurality of records 402₁, 402₂, 402₃, 402₄, 402₅, . . . , 402ₙ (generally referred to herein as records 402). Each record 402 comprises channel information, schedule information and program information for a particular program. Each record 402 comprises basic programming information 404 and, optionally, extended programming information 406. Multiple entries 402 of a program may exist in the database 220 if a program is listed multiple times in the program schedule.

In one embodiment, the basic programming information 404 comprises any channel, scheduling and programming information displayable on the program guide 300. For example, the basic program information 404 may comprise the channel showing the program, the start time of the program on the channel, the end time of the program on the channel, and the title of the program. The extended program information 406 comprises additional information about the program. For example, the extended program information 406 may comprise a description of the program, names of actors in the program and the name of the director of the program.

The program guide database 220 may also comprise other types of basic program information 404 and extended program information 406 depicted in FIG. 4. Another example of basic program information may include a rating of a program, or a type or classification of the program. Common types of programs include sports, drama, comedy, news, and the like. Exemplary forms of extended program information 406 may also include a review of the program or a description of the program in a different language.

It will be appreciated by those skilled in the art that the program guide database 220 may be formed using a plurality of objects, where each of the records 402 comprises a record object having associated with it a basic programming information object and, optionally, an extended programming information object. The various objects forming the database 220 may be interrelated. Moreover, each program object may be modified to avoid the use of an associated extended programming information object. Optionally, the extended programming information object may itself be modified to reduce the amount of data contained therein.

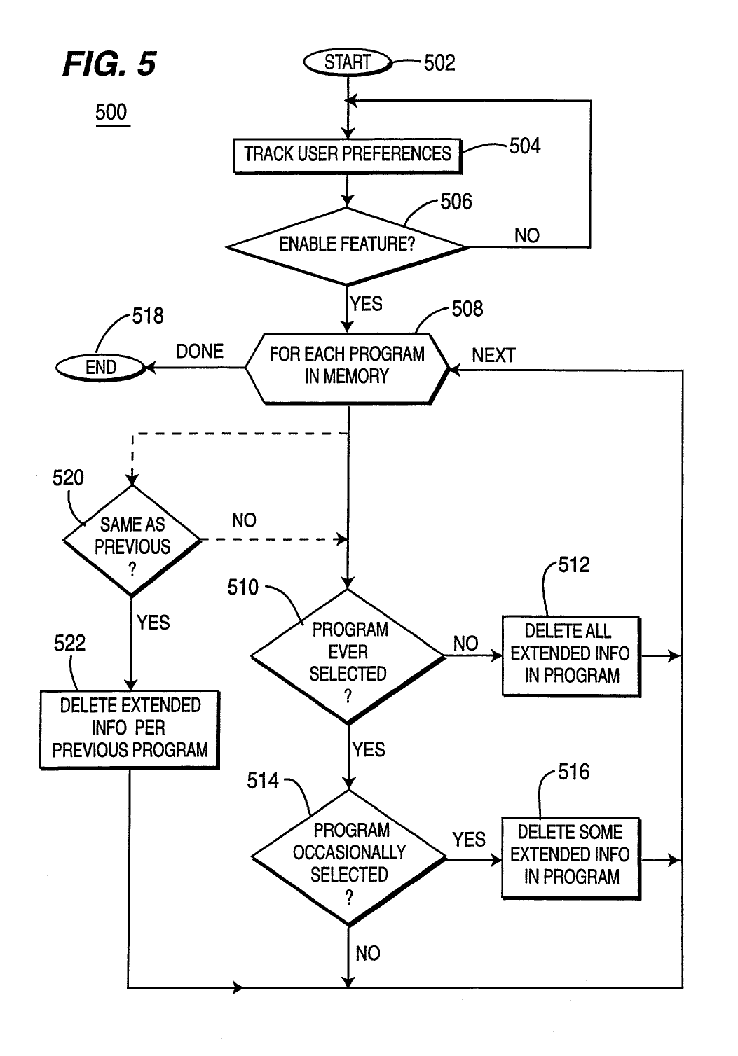

FIG. 5 depicts a flow diagram of a method 500 for allocating the memory 204 in the receiver 106. The method 500 uses the viewing preferences of a viewer to modify the amount of programming guide information to store for each program in the memory 204 of the receiver 106. Although the method 500 is described with respect to the removal of extended program information, e.g., extended text information, for programs of little or no interest to a viewer (non-preferred programs), the method 500 may be applied to channels of little or no interest to the viewer (non-preferred channels).

The method 500 starts at step 502 and proceeds to step 504, where user preferences are tracked using the program guide application 216. The tracking of user preferences comprises, for example, determining how often a viewer watches or selects each program. At step 506, a query determines whether to enable the feature of removal of extended program information based upon user preferences. In one embodiment, the use of user preferences to selectively remove extended program information is implemented as a feature or tool of the memory allocation software 218.

At step 508, each program stored in the memory 204 is processed. At step 510, a query determines whether a program has ever been selected. If the program has not been selected during at least a predetermined period, then at step 512 (some or all) all of the extended program information for the non-selected program is deleted. The method 500 then returns to step 508 where the next program is processed.

If the program has been selected, the method 500 proceeds from step 510 to step 514, where a query determines whether the program has been only occasionally selected. Namely, step 514 determines whether a viewer has selected a program (for viewing) less than a threshold number of times during at least a predetermined time period. If the program has been only occasionally selected, then at step 516 some of the extended information for the program is deleted. Step 516 may perform a selective deletion of extended information, i.e., some types of extended information may have higher priority and are less likely to be deleted. After step 516, the method 500 proceeds to step 508 where the next program is processed.

If the program has not been occasionally selected, the method 500 returns directly to step 508 where the next program is processed. In this situation, there is no removal of extended programming information since the viewer has selected or viewed the program at least a threshold number of times.

Once all the programs are processed, the method 500 terminates at step 518. Although the above-described method 500 provided two levels information pruning, i.e., deleting or removing extended programming information, other embodiments of the method 500 may implement different levels of information pruning.

In one embodiment, prior to performing steps 510 through 516, a query is made at an optional step 520 to determine whether the program is the same or similar to a previous program. That is, at optional step 520, a determination is made as to whether the program being processed is of the same type as a previously processed program. If the program is of the same type as a previously processed program, then at step 522 the extended information associated with the program is processed in a manner consistent with the extended information associated with the previous program. That is, at step 522 the extended information associated with the presently processed program is deleted (or added) to the extent that the extended information associated with the previously processed program was deleted (or added). In this manner, those programs of a type similar to previously processed programs may be rapidly modified according to the invention. For example, if a program of a certain type (e.g., action movies) is non-preferred by a user, all programs of this type may have associated extended information deleted entirely or in part (depending, for example, upon the number of times programs of this type are selected).

Although various embodiments which incorporate the teachings of the present invention have been shown and described in detail herein, those skilled in the art can readily devise many other varied embodiments that will still incorporate these teachings.

What is claimed is:

1. A method for adaptively storing in a memory program guide information for a plurality of programs, said method comprising:
determining whether a first program in said program guide is non-preferred by a user; and
reducing program guide information associated with said first program from said memory if said first program is non-preferred by said user.

2. The method of claim 1 wherein said determining comprises:
determining whether said first program was viewed by said user less than a threshold number of times; and
identifying said first program as non-preferred if said first program was viewed less than the threshold number of times.

3. The method of claim 1 wherein said determining comprises:
determining whether said first program is of a same type as another program that was viewed by said user less than a threshold number of times; and
identifying said first program as non-preferred if said first program and said another program are of the same type.

4. The method of claim 1 wherein said program guide information comprises basic program information and extended program information, said program guide information associated with said first program being reduced by deleting respective extended program information from memory.

5. The method of claim 4 wherein said reducing comprises:
removing extended program information for said first program if said first program is non-preferred.

6. The method of claim 4 wherein said reducing comprises:
removing at least a portion of extended program information for said first program if said first program is non-preferred.

7. The method of claim 1 further comprising:
determining whether a second program in said program guide is of interest to the user; and
adding program guide information for said second program if said first program is of interest to the user.

8. The method of claim 7 wherein said step of determining whether said second program comprises:
monitoring a viewing history of the user;
determining whether said second program was viewed more than a threshold number of times using said viewing history; and
identifying said second program as preferred if said second program was viewed more than the threshold number of times.

9. The method of claim 7 wherein said step of determining whether said second program comprises:
monitoring a viewing history of the user;
determining whether said second program is of a same type as another program that was viewed more than a threshold number of times in said viewing history; and
identifying said second program as preferred if said second program and said another program are of the same type.

10. The method of claim 1 wherein at least one of said plurality of programs is broadcast from one of a satellite and a terrestrial broadcasting center.

11. The method of claim 1 wherein each of said plurality of programs comprises at least one of a television program, a live broadcast, and an advertisement.

12. The method of claim 1 wherein said program guide information comprises Advanced Program Guide (APG) information.

13. An apparatus for providing a program guide listing a plurality of channels, a program schedule for each channel, and a plurality of programs for each channel, said apparatus comprising:
a tuner for tuning a video signal received via an antenna, where said video signal contains program guide information;
a demodulator for demodulating said tuned video signal;
a decoder for decoding said demodulated video signal;
a memory for storing said decoded programming guide information, and a memory allocation software; and
a processor, upon executing said memory allocation software, is configured to:
determine whether a first program in said program guide is non-preferred by a user; and
reduce program guide information associated with said first program from said memory if said first program is non-preferred by said user.

14. The apparatus of claim 13 wherein said program guide information comprises basic program information and extended program information.

15. The apparatus of claim 14 wherein all of said extended program information is removed for said first program if said first program is of no interest to the user.

16. The apparatus of claim 14 wherein a portion of said extended program information is removed for said first program if said first program is of little interest to the user.

17. The apparatus of claim 13 wherein at least one of said plurality of programs is broadcast from one of a satellite and a terrestrial broadcasting center.

18. The apparatus of claim 13 wherein each of said plurality of programs comprises at least one of a television program, a live broadcast, and an advertisement.

19. The apparatus of claim 13 wherein said program guide information comprises Advanced Program Guide (APG) information.

20. An apparatus for adaptively storing in a memory program guide information for a plurality of programs, said apparatus comprising:
means for determining whether a first program in said program guide is non-preferred by a user; and
means for reducing program guide information associated with said first program from said memory if said first program is non-preferred by said user.
